(19) United States
(12) Patent Application Publication
(10) Pub. No.: US 2009/0323296 A1
(43) Pub. Date: Dec. 31, 2009

(54) Memory stick cover

(76) Inventor: Stephanie Sanzone, Lake Grove, NY (US)

Correspondence Address: Stephanie Sanzone, 10 Amboy Lane, Lake Grove, NY, 11755, US

(21) Appl. No.: 12/075,284

(22) Filed: Jun. 30, 2008

(51) Int. Cl. H01R 13/46

(52) U.S. Cl. 361/752

(57) ABSTRACT

A memory stick cover that allows a user to snap on a decorative element to customize the cover to the user's liking. The cover includes a top side, a pair of parallel long sides and a pair of parallel short sides. The cover is capable of snuggly fitting over a memory stick. The cover includes a male snap connector on its top side surface. The decorative element includes a female snap connector on its underside surface. The male and female snap connectors are capable of engaging each other so that the decorative element is attached in a removably replaceable manner. An alternate embodiment includes a decorative element that is permanent rather than removable and replaceable. Another alternate embodiment includes the decorative element snapping directly onto a memory sick.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of protective and/or decorative covers for electronic devices and more specifically to a memory stick cover.

Memory sticks are well known as storage devices for digital information. They are sometimes referred to as flash drives or flash cards or memory cards. As the memory sticks have evolved and become smaller, a key chain size stick has become popular, such as the “Cruzer” memory stick manufactured by Sandisk Corp.

Because these memory sticks are carried in a person's pocket or purse, the need for a protective cover has become evident. A number of patents have addressed the issue of a protective cover such as patents: D444,473, D452244, D554123, U.S. Pat. No. 7,092,256, U.S. Pat. No. 7,264,513, U.S. Pat. No. 7,287,705, U.S. Pat. No. 7,297,024 and applications: 2006/0009079, and 2006/0288169. However, the above listed patents have a deficiency in that they do not allow the user to customize his or her memory stick with a cover that includes decorative element that can be removed and replaced as often as desired. Additionally, the memory sticks themselves have not included a receiving element that would allow a user to snap on a decorative element. Finally, the prior art of memory stick covers has not included a way for a person to add a name tag so that the name tag becomes an integral part of the cover.

### BRIEF SUMMARY OF THE INVENTION

The primary object of the invention is to provide a cover for a way for a user to customize his or her memory stick.

Another object of the invention is to provide a cover for a memory stick that includes a decorative element.

Another object of the invention is to provide a cover for a memory stick that allows the user to add or replace a decorative element.

Another object of the invention is to provide a cover for a memory stick that allows the user to incorporate a personal name tag.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a memory stick cover comprising: a decorative element, a memory stick cover, said cover including a top side, a pair of parallel long sides and a pair of parallel short sides, said cover capable of snuggly fitting over a memory stick, said cover including a male snap connector on its top side surface, said decorative element including a female snap connector on its underside surface, and said male and female snap connectors capable of engaging each other so that said decorative element is attached in a removably replaceable manner. An additional embodiment includes a memory stick with a male snap half affixed to its top surface and capable of receiving a decorative element having a female snap half affixed to its bottom most surface. A further additional embodiment includes a memory stick cover with a decorative element permanently fixed in place. An additional embodiment includes a memory stick cover that allows a person to insert a name tag into the cover. A final embodiment includes a memory stick that has a depression built in and removable clear cover for allowing a person to insert a name tag.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a memory stick with a decorative element snapped in place.

FIG. 2 is a perspective view of a memory stick with a decorative element removed.

FIG. 3 is a side section view of a memory stick with a decorative element snapped in place.

FIG. 4 is a rear perspective exploded view of a decorative element with snap half removed.

FIG. 5 is a perspective exploded view of a memory stick with a snap on cover.

FIG. 6 is a top view of a memory stick with a decorative cover in place.

FIG. 7 is a rear perspective view of a decorative cover.

FIG. 8 is an exploded perspective view of a memory stick and a cover containing a name tag.

FIG. 9 is a perspective view of a memory stick and cover containing a name tag.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

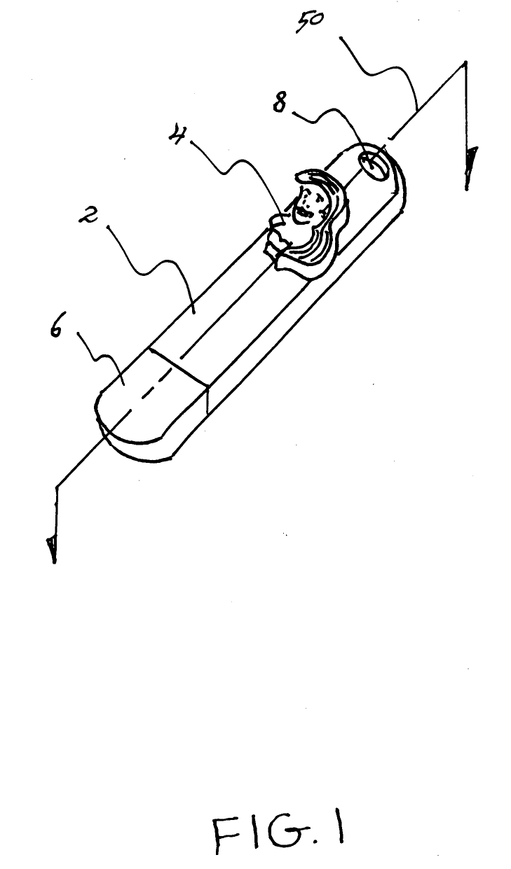

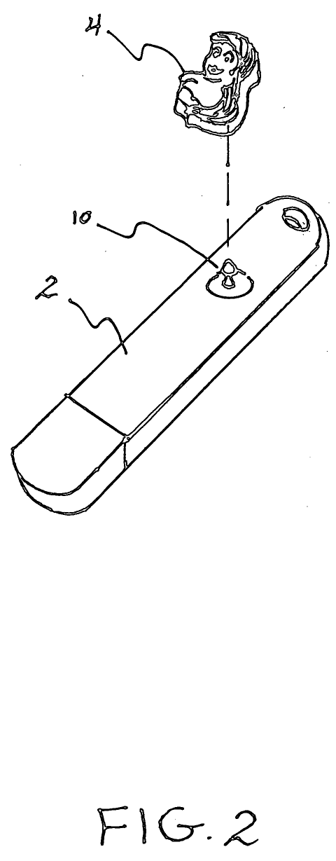

Referring now to FIG. 1 we see the most basic embodiment of the present invention. A memory stick 2 has been customized by a user by the addition of a decorative element 4. The memory stick is small enough to fit in a person's pocket and includes a key chain aperture 8 and a removable cover 6 that reveals a USB connector when removed. In this embodiment, the plastic housing of the memory stick is considered the cover. FIG. 2 shows that the decorative element 4 is removable and replaceable by means of a male snap 10 built into the top surface of the memory stick 2 and a female snap 14 located on the underside of the decorative element 4. In this way, a person can remove and replace the decorative element at any time.

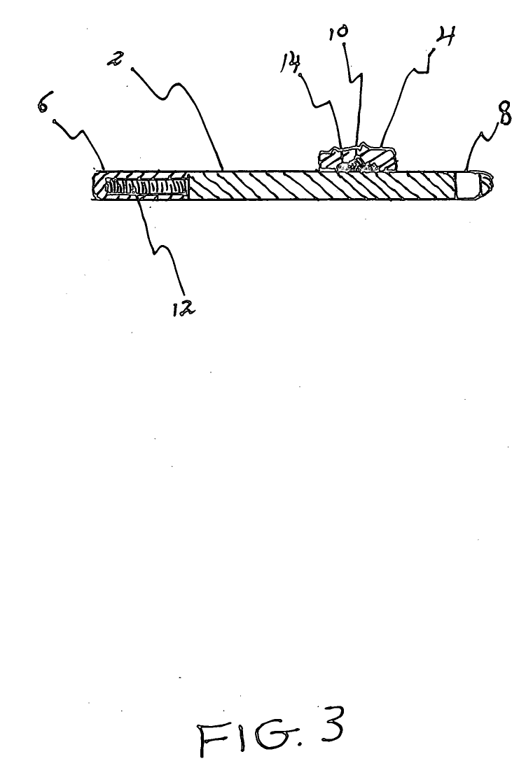

FIG. 3 shows a side section view of the memory stick 2 as defined by section line 50 shown in FIG. 1. This view clearly shows how decorative element 4 is held in place by male snap member 10 and female snap member 14. USB connector 12 can be seen within cover 6.

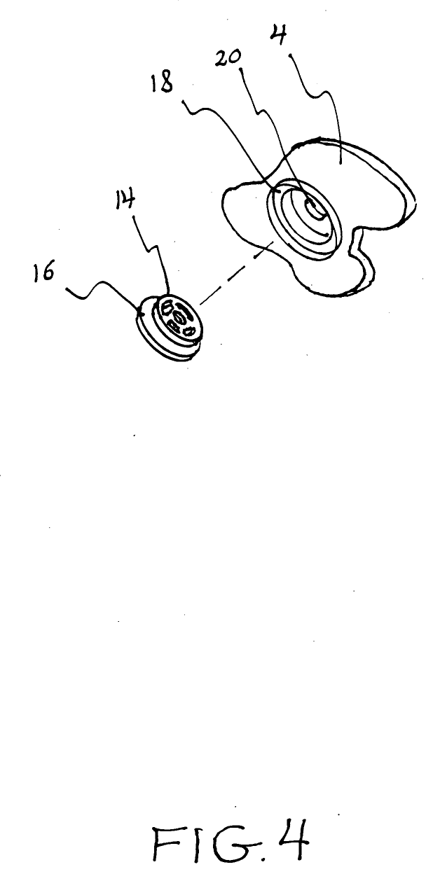

FIG. 4 shows a rear view of the decorative element 4. Female snap 14 is affixed to a recess in the rear of decorative element 4 and is fixed in place when flange 16 is welded to shoulder 18. Depression 20 allows room for the tip of male snap member 10.

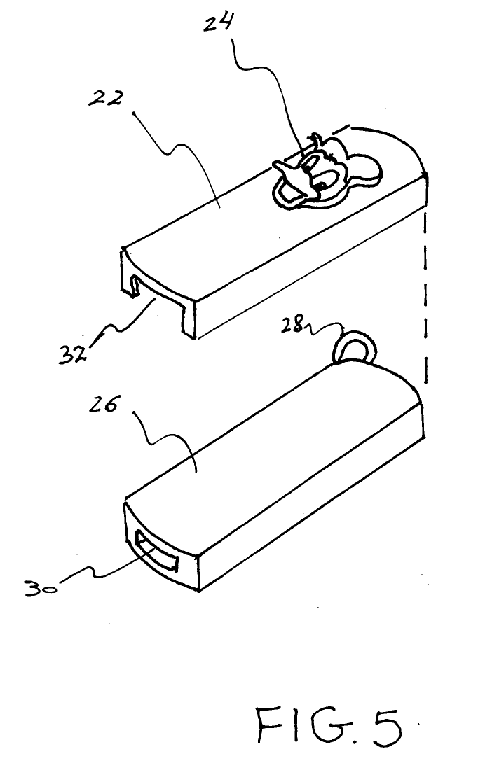

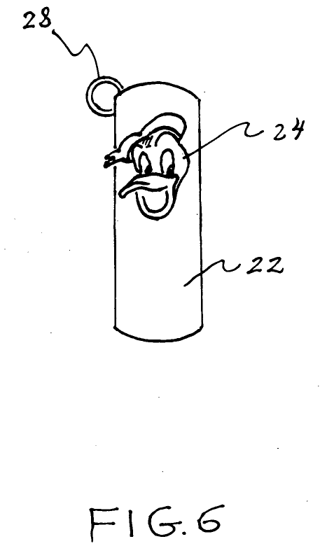

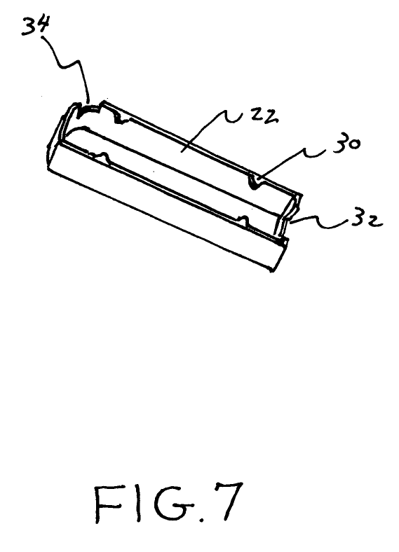

FIG. 5 shows an another embodiment of the invention where a separate cover 22 can be slid onto a memory stick 26. The cover 22 is open on the bottom allowing it to be pushed onto the top surface of memory stick 26. A decorative element 24 can be either permanently affixed to the top surface of cover 22, or it can be removably attached in the same way as described in FIGS. 1, 2, 3 and 4. This particular cover 22 is designed for a common memory stick made by Sandisk Corp called the Cruzer. It is a key chain sized device and includes a key ring 28 and a slide out USB connector 30. The cover 22 has a cutout 32 in one end to allow connector 30 to be slid out without removing the cover 22. and also includes a cutout 34 shown in FIG. 7 that allows the key ring to extend through the cover 22. FIG. 7 also shows return tabs 30 that flex out of the way when inserting memory stick 26 but flex back into place after the memory stick 26 is in place thereby retaining the cover 22 onto the memory stick 26. FIG. 6 is a top plan view of the cover 22 with the memory stick 26 in place and key ring 28 protruding through the cutout 34 in the cover 22. Decorative element 24 can be fixed in place or removable and replaceable as explained above.

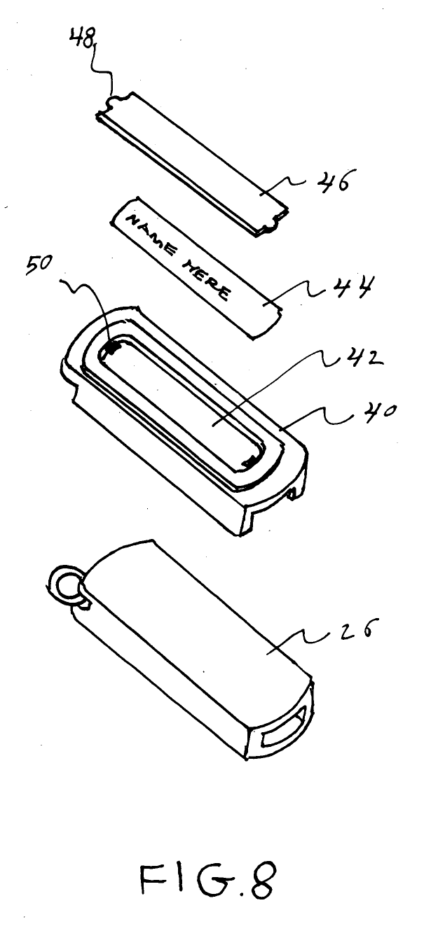

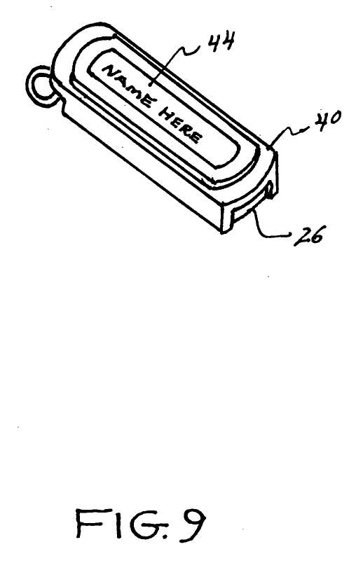

FIG. 8 shows still another embodiment of the invention where the cover 40 includes a depressed area 42 where a name tag 44 can be placed and a transparent cover 46 can be placed on top of the name tag 44 thereby protecting it from dirt and scuffing. The clear cover is made of slightly flexible transparent plastic such as acrylic and has opposing tabs 48 that can engage receptacles 50 in the cover 40 thereby locking the transparent cover 44 in place. FIG. 9 shows The name tag version of the invention in its final form with name tag 44 in place and memory stick cover 40 slid onto memory stick 26. Obviously, another embodiment would be to manufacture the memory stick 26 with the recessed area 42 built in and ready to accept a name tag 44 and transparent tag cover 46.

Therefore, from the above description, there are a total of five embodiments of the present invention. One is to incorporate a male snap into the top surface of a memory stick and to provide decorative elements that have a female snap built into their back side so that the decorative elements can be snapped directly onto the memory stick. The second is to provide a cover for a memory stick that has a decorative element parentally fixed to its top surface. The third embodiment is to provide a cover for a memory stick where the decorative element can be removed and replaced by the snap feature described in version one. The fourth embodiment is to provide a cover for a memory stick that includes a depressed area that can accept a name tag and a transparent cover to go over the name tag. The fifth embodiment is to provide a memory stick where the name tag depression is built into the top surface of the memory stick thereby eliminating the need for the cover.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. memory stick cover comprising:
a decorative element;
a memory stick cover;
said cover including a top side, a pair of parallel long sides and a pair of parallel short sides;
said cover capable of snuggly fitting over a memory stick;
said cover including a male snap connector on its top side surface;
said decorative element including a female snap connector on its underside surface; and
said male and female snap connectors capable of engaging each other so that said decorative element is attached in a removably replaceable manner.

2. An alternate embodiment of said memory stick cover as claimed in claim 1 wherein decorative element is permanent rather than removable and replaceable

3. Memory stick cover as claimed in claim 1 wherein said cover includes cutout areas to allow a key ring located on said memory stick to protrude out.

4. Memory stick cover as claimed in claim 1 wherein the downwardly facing edges of said cover sides include a plurality of inwardly facing fingers at ninety degrees from said long parallel sides that allow said cover to snap onto said memory sick in a removable and replaceable manner.

5. An embodiment of said memory stick cover as claimed in claim 1 wherein said cover includes a depressed area located on said top surface and a transparent cover plate that can be inserted and locked into said depressed area in a standard way so that said user can sandwich a name tag between said depressed surface and said transparent cover plate.
